(19) United States
(12) Patent Application Publication
(10) Pub. No.: US 2003/0137841 A1
(43) Pub. Date: Jul. 24, 2003

(54) Large group of decoration light string

(76) Inventor: Jeng-Shyong Wu, Hsin-Chu City (TW)

Correspondence Address: BUCKNAM AND ARCHER, 1077 Northern Boulevard, Roslyn, NY, 11576-1696, US

(21) Appl. No.: 10/348,096

(22) Filed: Jan. 21, 2003

(30) Foreign Application Priority Data
Jan. 21, 2002 (CN) 02201687.2

(51) Int. Cl. F21S 13/14

(52) U.S. Cl. 362/252; 362/251; 362/806; 362/808; 40/442

(57) ABSTRACT

The present invention is to provide a large group of decoration light string. The decoration light string is generally used multiple luminaries connected with multiple electrical conductor with serial, parallel or serial and parallel circuit loop into little group of decoration light string. Thereafter, comprising multiple little groups of decoration light strings into a large group of decoration light string. In more detail, the present invention provides a large group decoration light string, thus, luminaries are connected by the power connector via serial, parallel or serial and parallel circuit loop into little group of decoration light string. Then, comprising multiple little group decoration light strings establish a large group of decoration light string. Multiple little group decoration light strings are flashing randomly or orderly via this control device thus establish motional style.

### BACKGROUND OF THE INVENTION

The present invention generally relates to a large group decoration light string, more particularly relates to comprising multiple little group decoration light strings into a large group decoration light string. By means of controlling these luminaries in little group decoration light string flashing randomly or orderly, it is able to produce obviously repeating motion style.

Light decoration has artistic result, especially in the evening or in the dark places that includes indoor and outdoor. By means of light itself and decoration, designed style and patterns, such decoration will cause noticeable results. At light decoration moment, the states of expression are both stable and motional. The motional state is by means of flashing the luminaries or carrying luminaries mechanically to let the light decoration string appear motional. General speaking, the motional light decoration style is more attractive than stable light decoration. However, the motional light decoration is still not diversify and highly costs in manufacture, furthermore they all requires large scale to be shown. Such as the lighting decoration in the large-scale square or plaza, their motional simulation results are still not very well and will face destroy and discard after exhibition.

In order to increase motional light decoration result and multiple variation even the little group can also show its result obviously. Thus the present invention provides a large group decoration light string, comprising many little group decoration light strings. This little group decoration light string comprises multiple luminaries being connected with multiple electrical conductors in series, parallel and series and parallel. By controlling the lighting flashing orderly in the little group decoration light strings these make large group decoration light string appearing motional style, such as repeat orderly just like fireworks or a space shuttle to take off.

The present invention provides a large group decoration light string, comprising luminaries connect by the power connector via serial, parallel or serial and parallel circuit loop into little group of decoration light string. Then these multiple little group decoration light strings are orderly to establish a large group of decoration light string.

Another object of the present invention is to provide a large group decoration light string comprising luminaries connect by the power connector via serial, parallel or serial and parallel circuit loop into little group of decoration light string. Then comprising multiple little group decoration light strings are orderly to establish a large group of decoration light string. Multiple little group decoration light strings are flashing randomly or orderly via this control device thus establish motional style.

### BRIEF DESCRIPTION OF THE DRAWINGS

FIG. 1 is a perspective view of the first embodiment of the present invention showing luminaries being connected into a network style with electrical conductor or non-electrical connector.

FIG. 2 is a perspective view of the second embodiment of the present invention showing luminaries being connected into a network or connected style with electrical conductor or non-electrical connector.

FIG. 3 is a perspective view of another embodiment of the present invention showing doughnut shapes of little group decoration light string and large group decoration light string.

FIG. 4 is a perspective view of another embodiment of the present invention.

FIG. 5 is a perspective view of a further embodiment of the present invention.

FIG. 6 is a perspective view of a further embodiment of the present invention.

FIG. 7 is a perspective view of a further embodiment of the present invention.

FIG. 8 is a perspective view of a further embodiment of the present invention.

FIG. 9 is a perspective view of a further embodiment of the present invention.

FIG. 10 is a perspective view of a further embodiment of the present invention.

FIG. 11 is a perspective view of a further embodiment of the present invention.

FIG. 12 is a perspective view of a further embodiment of the present invention.

### DESCRIPTION OF PREFERRED EMBODIMENTS

The above mentioned luminaries are connected with multiple electrical conductors by use the non-electrical connectors twisted with electrical conductor to increase the connecting enhancement. The said luminaries can be vacuum bulb, filling air bulb and LED to attach to the lamp base and lamp holder. The power connector can be use single or multiple power socket or tail connected mutually. The above said luminaries connect with electrical conductors, non-electrical connectors, fixed device or mutual twisted to establish little group decoration light string. The luminaries, lamp bases or electrical conductors are fixed by the fixed device, supporting frame or film, establish plane or three dimensional little group decoration light string. The little group decoration light strings connect with electrical conductors, non-electrical connector or fixed device to form and to establish a large group decoration light string. The little group decoration light string can be separated, over lapping or containing one or the other to form plane or three dimensional large group decoration light string. A large group decoration light string uses the same or different scale of little group decoration light strings. Said large group decoration light string is to use many little group decoration light strings to adjust its frame space or distance apart from one to the other become changeable shape.

Further, a large group decoration light string can use the control device to make many little group decoration light strings flashing. Starting from the first group decoration light string flashing, then after a certain period of time, the second group decoration light string is flashing, and then after a certain period of time, the third group decoration light string is flashing and so on so for. All group decoration light strings will die out simultaneously until all the groups of light had done. Then repeat the motion thus appear just like fireworks shape. A large group decoration light string is to use the control device to make many little group decoration light strings luminaries by means of on or off, adjust the speed to let the motion save on the temp sense. It is a straight line from the sense point of view then extent it to round shape or random motional shape. A large group decoration light string is to use the control device to control the luminaries in many little group decoration light strings working simultaneous fully or partially, so that the luminaries are flashing fully or partially synchronous bright up or dying out. Said control device can be either manually or automatically start or weight device, let luminaries start and operate manually or automatically. This operation transmits the data to the signal processor via either IR or RF.

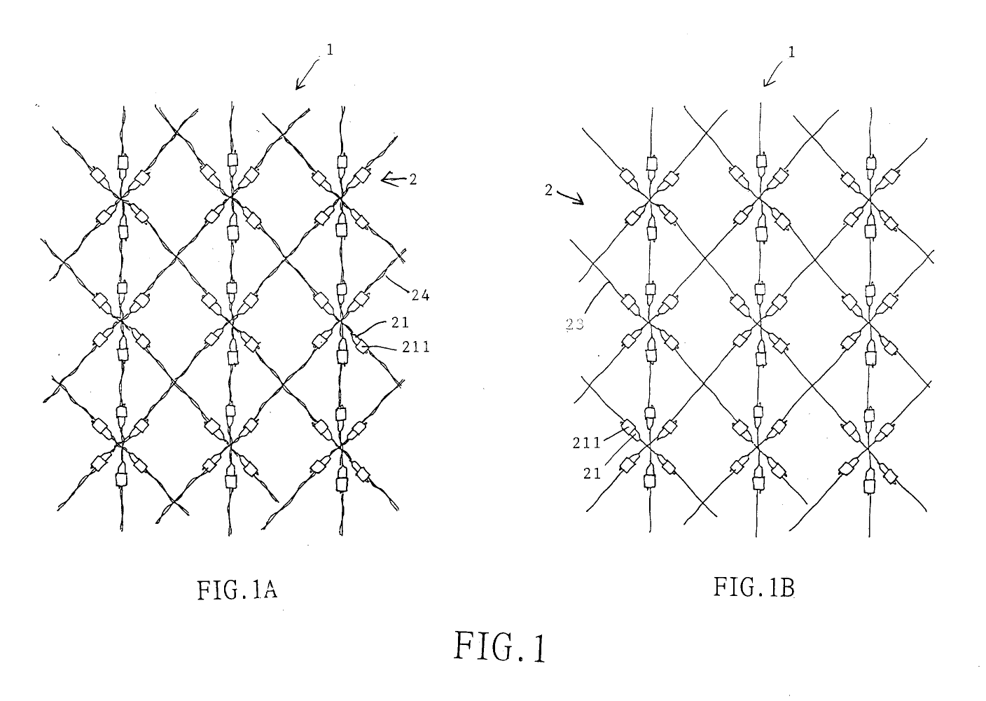

Now referring to FIG. 1 including FIGS. 1A and 1B, the luminaries 21 via electrical conductor 23 or non-electrical connector 24 connect into network style. One end of the luminaries 21 is fixed on the lamp holder 211. In these drawings, six luminaries 21 are to form a little group decoration light string 2, then by means of the connection of electrical conductor 23 and non-electrical connector 24 to form a large group decoration light string 1. This non-electrical connector 24 can be metal string, non-metal string or combination of both, but its use is not to be a conductor. Non-metal string can be such as plastic string.

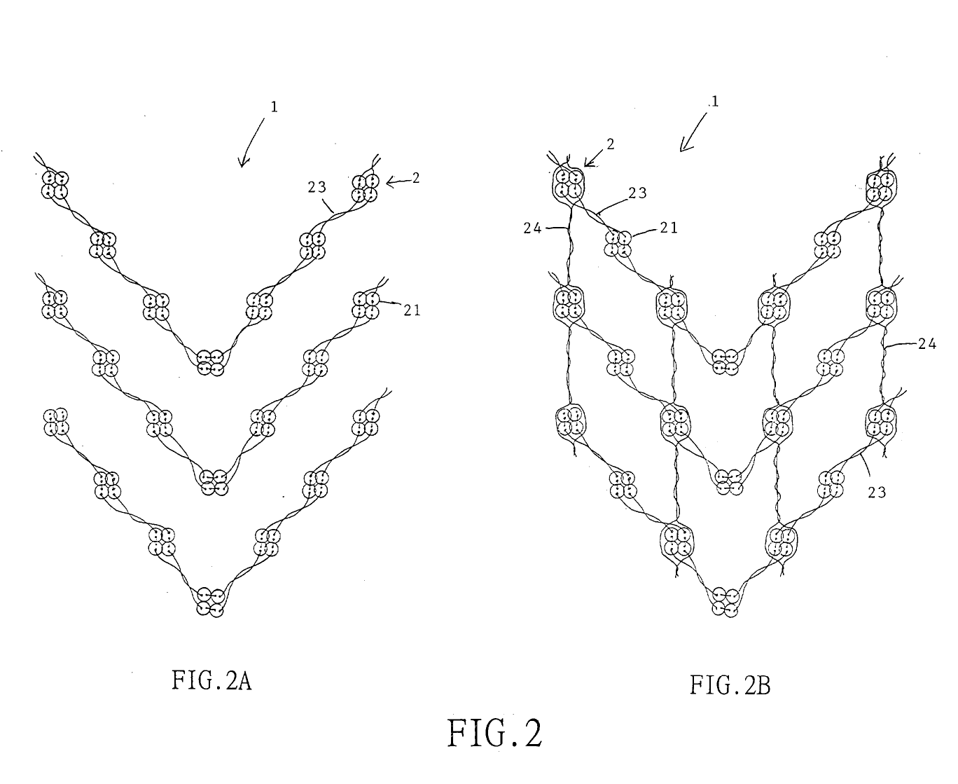

Referring to FIG. 2 including FIGS. 2A and 2B, four luminaries 21 become a little group decoration light string 2, every little group decoration light string 2 then by means of the connection of electrical conductor 23 and non-electrical connector 24 to form a large group decoration light string 1. FIG. 2A is showing in order in “V” shape, and FIG. 2B is showing in order in “V” paling network shape.

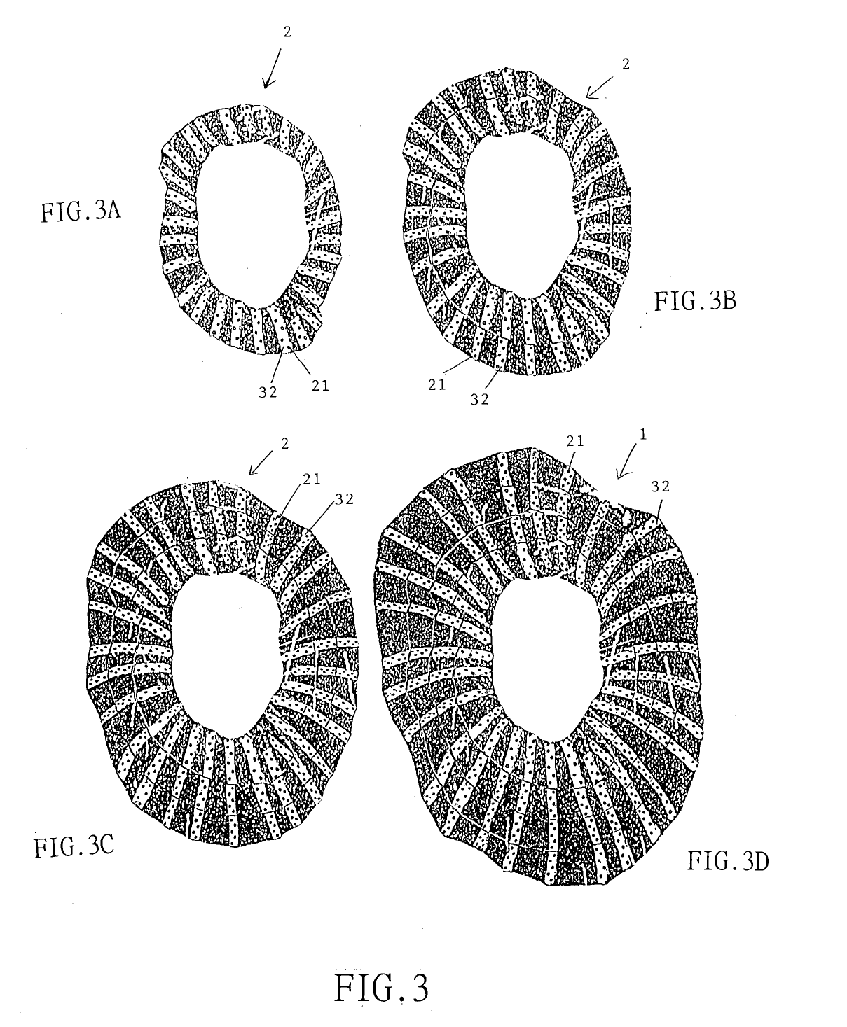

Referring to FIG. 3 including FIGS. 3A, 3B, 3C and 3D, the FIG. 3A shows an embodiment of a little group decoration light string 2 of the present invention. It is including a round shape supporting face (black part as shown), every luminaries 21 fixed on the wire 32, many of wires 32 appearing radiate shape fixed on the round shape supporting face. FIG. 3B is showing different two diameters like FIG. 3A of little group decoration light string 2. The outer diameter of the little group decoration light string is equal to inner diameter in another little group decoration light string thus mutual each other. FIG. 3C is showing three different diameters such as FIG. 3A to show the combination of three little group decoration light strings 2. FIG. 3D is showing four different diameters such as FIG. 3A to show the combination of four little group decoration light strings 2. By means of controlling four little group decoration light strings 2 flashing orderly in FIG. 3D can appearance motional effect.

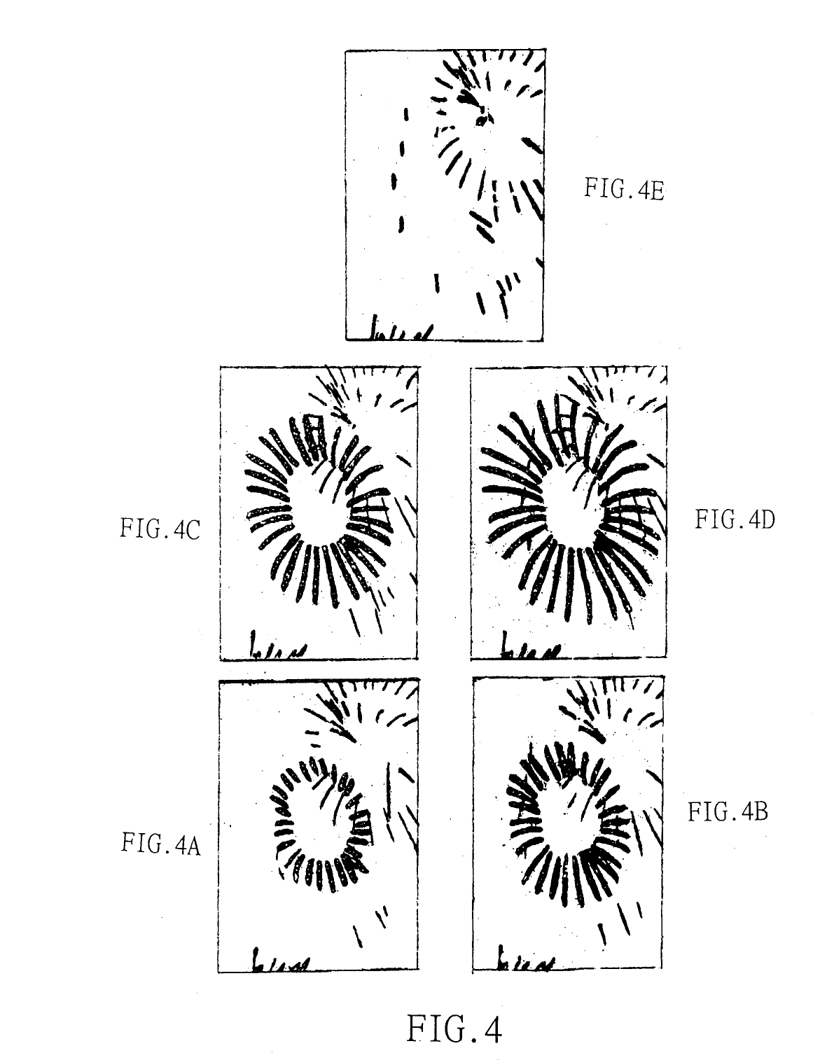

Referring FIG. 4 including FIGS. 4A, 4B, 4C, 4D and 4E, it is an embodiment of FIG. 3 showing a large group decoration light string 1 to be used as fireworks shapes. In order to obtain a better result of showing, every large group decoration light string 1 may be used four or above of little group decoration light strings 21. For example, during operation, from the direction of inner to outer circle in accordance with time flashing on and off of little group decoration light strings 21, thus to obtain the status of fireworks effect. In the better way, it is to use different color of luminaries 21 to be diversified the effect.

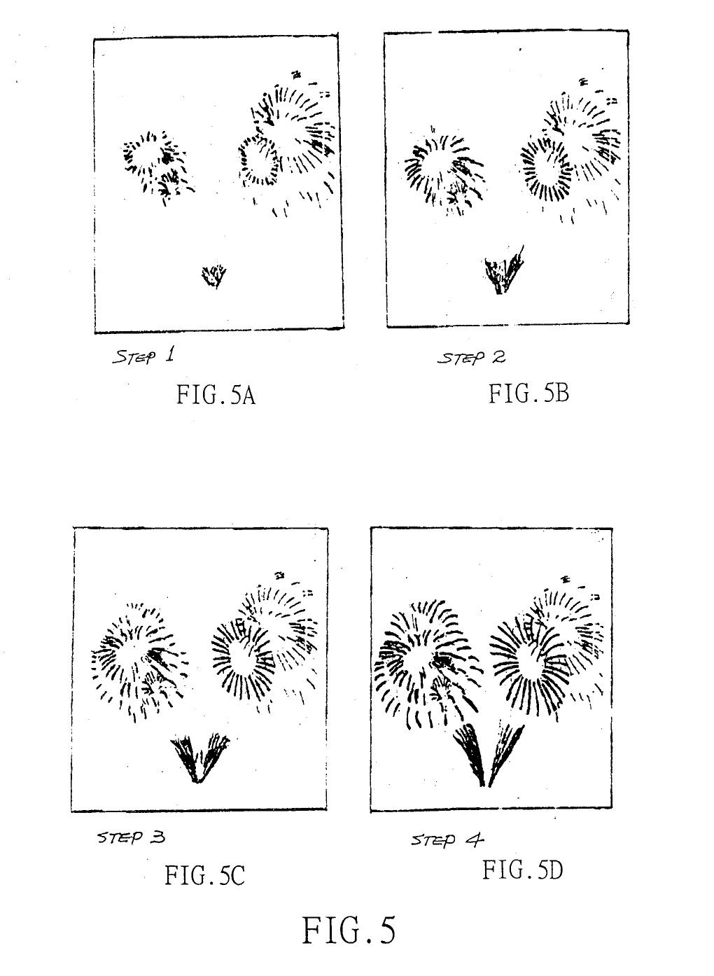

Referring FIG. 5 including FIGS. 5A, 5B, 5C and 5D, it is a further embodiment of FIG. 4 showing a large group decoration light string 1. These two large group decoration light strings 1 plus a light bundle into a whole body. Thus, by means of the control of light bundle and flashing orderly of the little group decoration light string 2 inside the large group decoration light string 1 to be appeared a perfect firework effect.

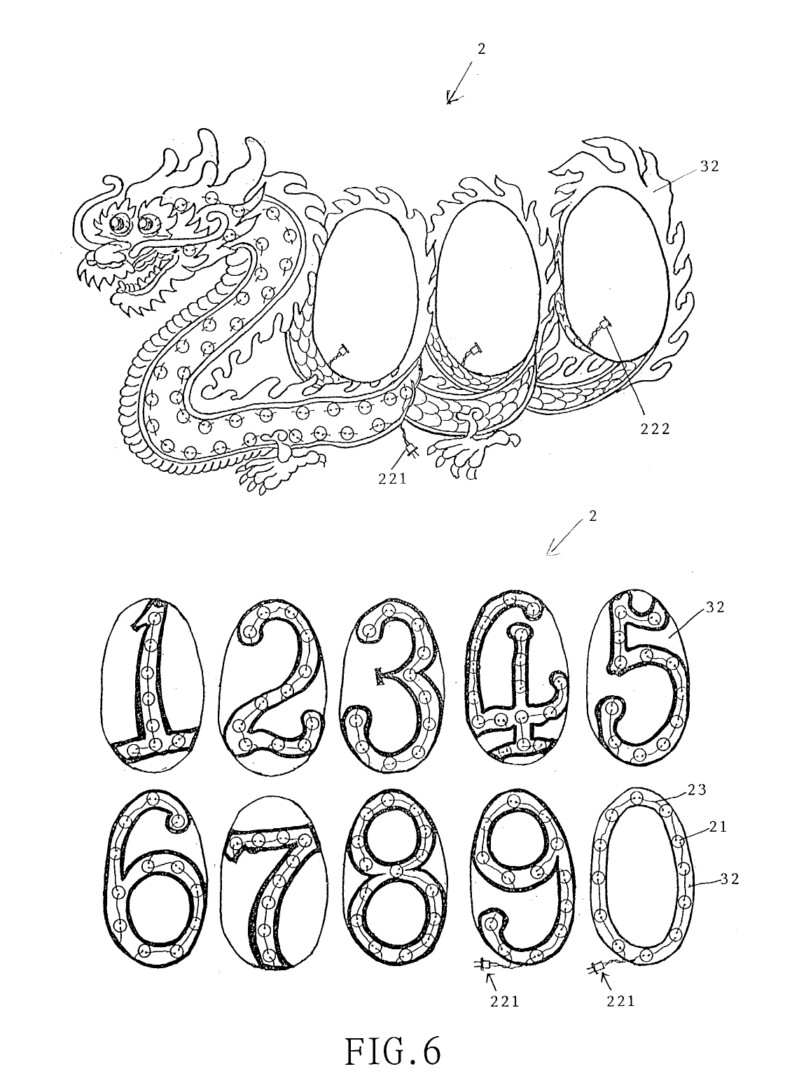

Referring FIG. 6 including upper and lower drawings, the lower drawing is showing numerical numbers in each little group decoration light string 2. These numerical numbers are fixed on the ellipse board 32. The edge of ellipse board 32 has an electric plug 221. The upper drawing is showing a dragon shape decoration light string, there are three ellipse frames on the back of this dragon body for three numerical number ellipse boards 32 thus to establish a large group decoration light string. There has the plug 222 (female plug) inside each ellipse board that provides to connect the plug 221 (male plug) in each ellipse board 32, also there are luminaries 21 on the side of the dragon body. Similarly, each little group decoration light string 2 can be controlled their flashing on and off orderly thus produce attractive result.

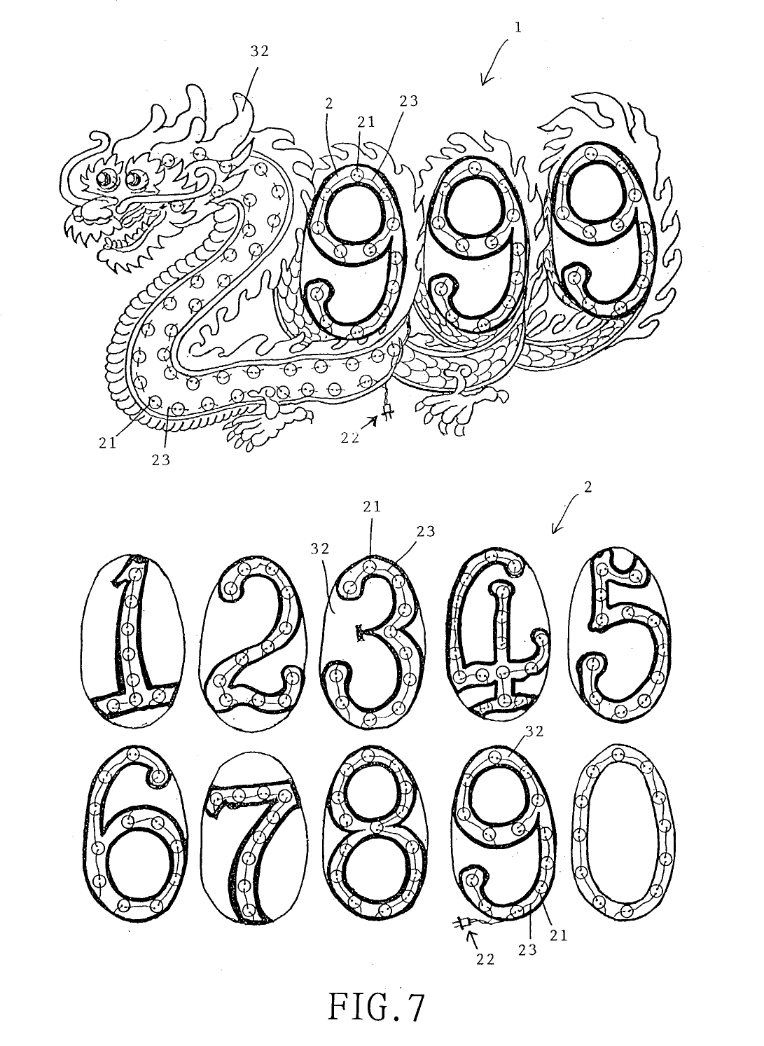

Referring FIG. 7 including upper and lower drawings, the lower drawing is similar in the lower drawing in FIG. 6, but the upper drawing has already installed numerical number ellipse board 2, thus it is a little group decoration light string 2.

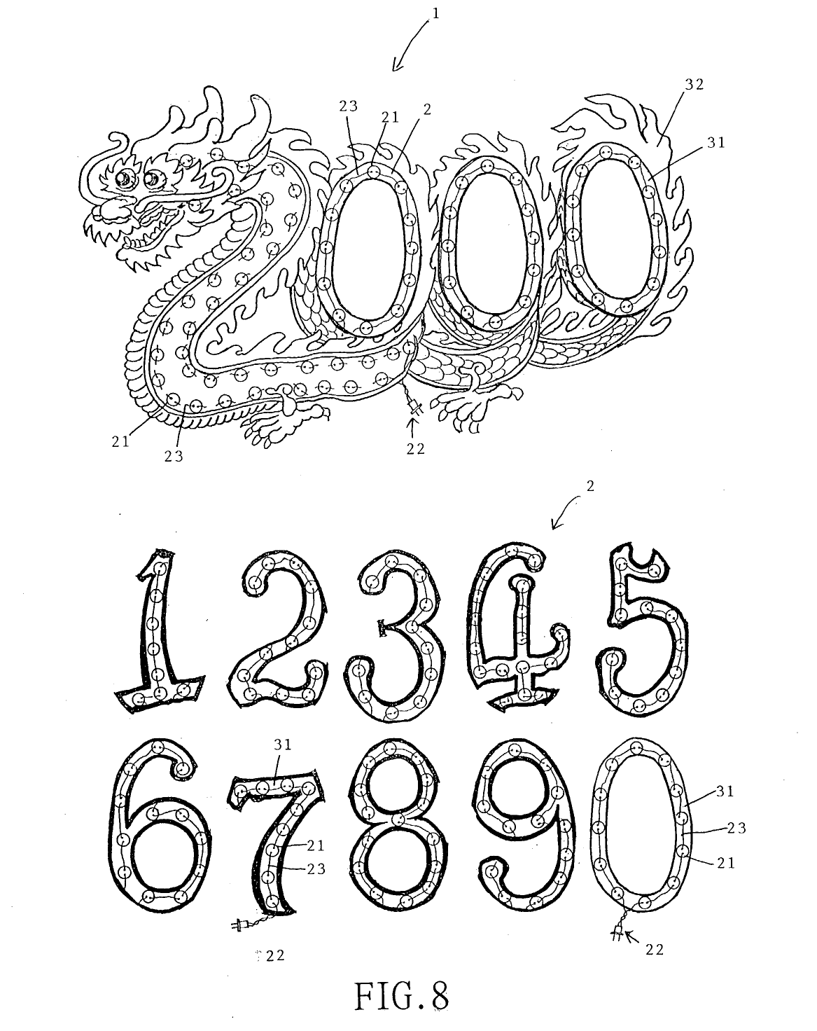

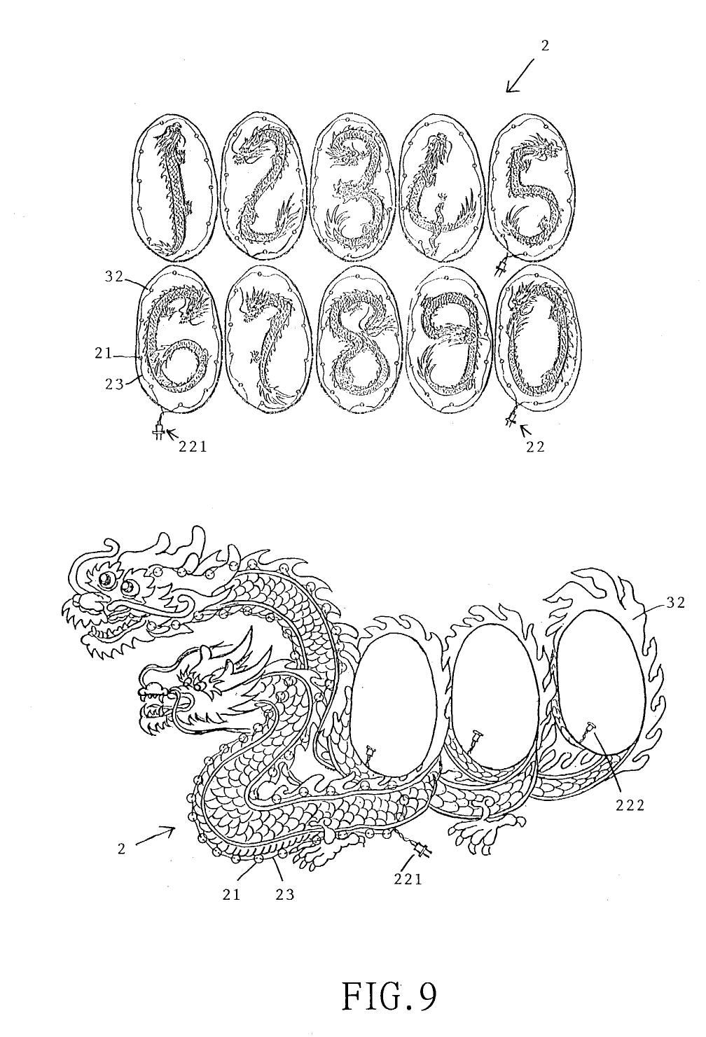

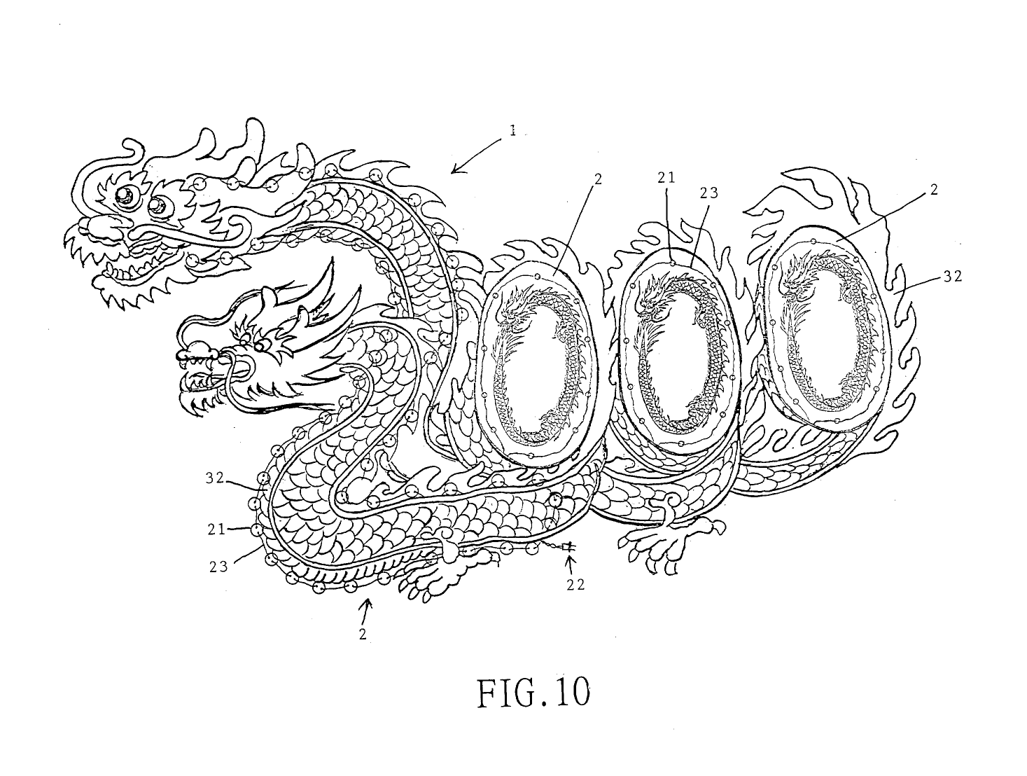

Referring FIGS. 8, 9 and 10, this is similar in FIG. 7 in which the appearance presents in different style.

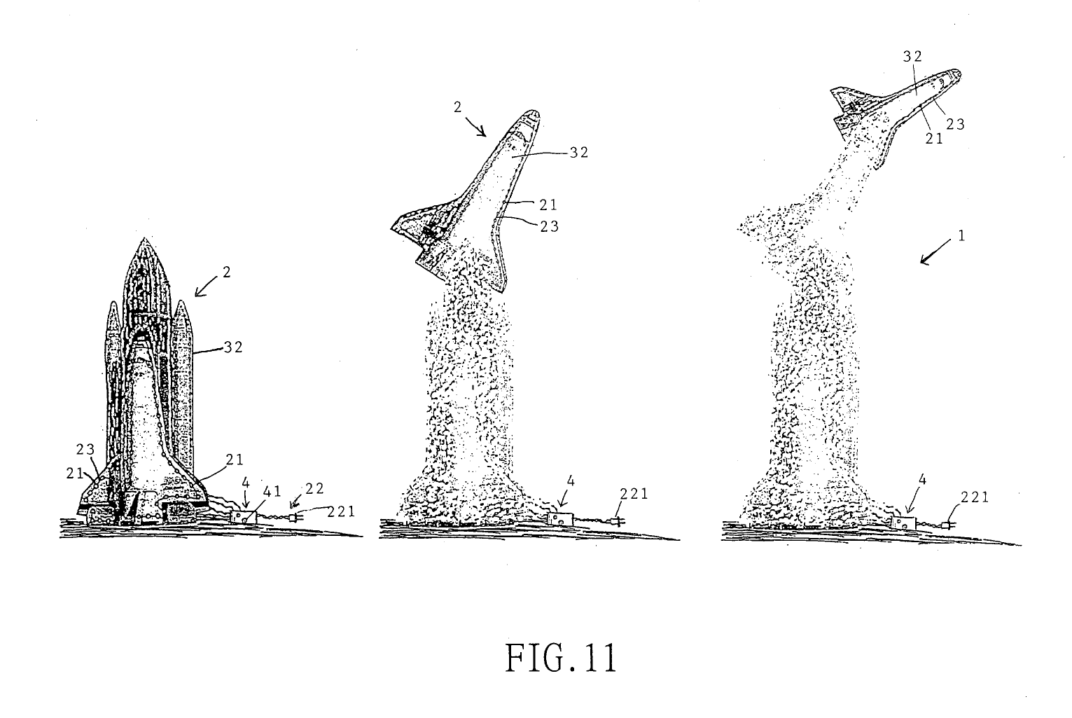

Referring FIG. 11, it shows a perspective view of a large group decoration light string, and there are all appearance in space shuttle shape. It is showing the space shuttle 2 not yet take off in the left drawing. In the bottom of the space shuttle 2, there are a control device 4, starting device, weight device 41, power connecter 22 and so on. The middle drawing is the status of space shuttle 2 taking off and including the pattern of torch shape. The right drawing is space shuttle 2 for further previously image of the space shuttle 2. By means of the control device to control the flashing sequence in each little group decoration light string 2, it can present the result of motional status, greatest and pretty space shuttle 2 taking off.

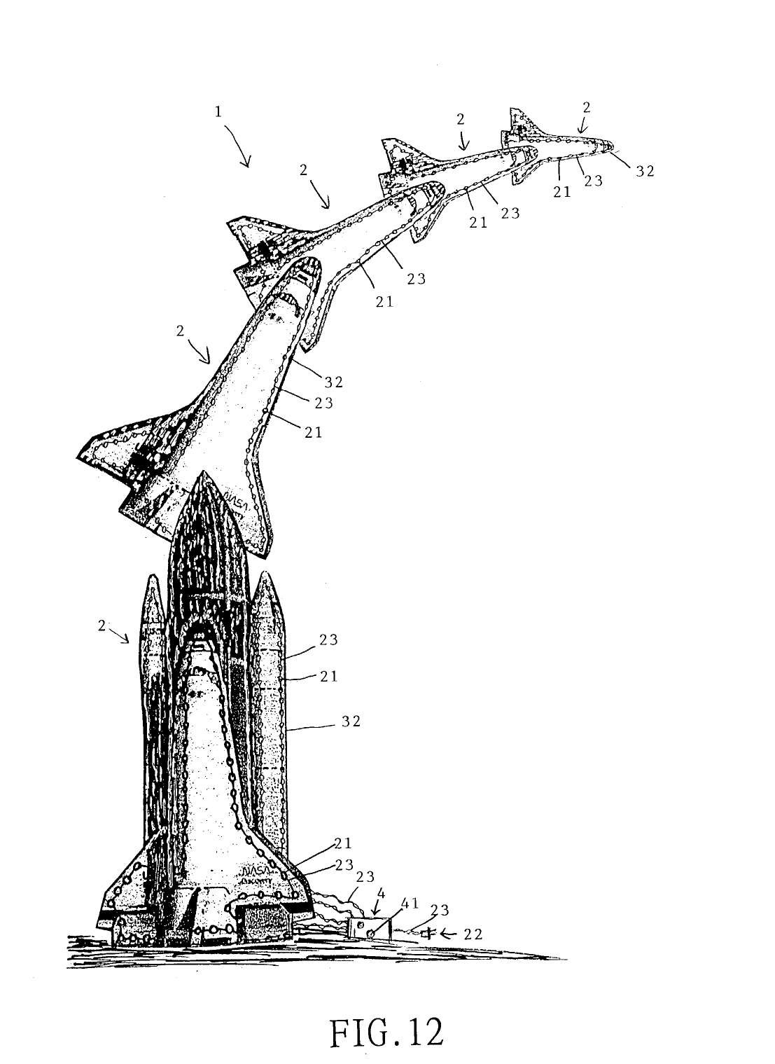

Referring FIG. 12, it shows a perspective view of a large group decoration light string, which also performs a space shuttle shape. They made up by use different height of space shuttle 2, i.e. little group decoration light string 2, then to connect them to form a large group decoration light string 1. By means of the control device to control the flashing sequence in each space shuttle 2, which can perform in different way of FIG. 11 to present the result motional status, greatest and pretty space shuttle 2 taking off.

The features and preferred embodiments of the present invention have been described in the foregoing specification. The invention intended to be protected herein, however, is not to be construed as limited to the particular forms disclosed. Variations and changes, which maybe made by those skilled in the art, are with out departing form the scope of the present invention.

What I claimed is:

1. A large group of decoration light string comprising multiple luminaries being connected with multiple electrical conductors in series, parallel and mixture of series and parallel to form a circuit loop of little group of decoration light string, then comprising many little group of decoration light strings to establish larger group of decoration light string.

2. A large group decoration light string as claimed in claim 1, wherein the luminaries being connected with multiple conductors by use the non-electrical connectors twisted with electrical conductor to increase the connecting enhancement.

3. A large group decoration light string as claimed in claim 1, wherein the luminaries being vacuum bulbs, bulbs filling with air and LED to be installed the lamp base and lamp holder.

4. A large group decoration light string as claimed in claim 1, wherein the power connectors are using single or multiple power sockets or tail connectors connected mutually.

5. A large group decoration light string as claimed in claim 1, wherein the luminaries being connected with electrical conductors, non-electrical connectors, fixed device or mutual twisted to establish little group decoration light string.

6. A large group decoration light string as claimed in claim 5, wherein the luminaries connected to the fixed device, supporting frame or film, the lamp holder or electrical conductors establish plane or three dimensional little group decoration light string.

7. A large group decoration light string as claimed in claim 1, wherein the little group decoration light string being connected with electrical conductors, non-electrical connectors or fixed device to establish to large group decoration light string.

8. A large group decoration light string as claimed in claim 7, wherein the little group decoration light string can be separated, over lapping or including one or the other to establish plane or three dimensional large group decoration light string.

9. A large group decoration light string as claimed in claim 1, wherein using the same or different scale of little group decoration light string.

10. A large group decoration light string as claimed in claim 1, wherein using the same or different shape of little group decoration light string.

11. A large group decoration light string as claimed in claim 1, wherein using many little group decoration light strings to adjust their frame space or distance apart from one to the other become changeable shape.

12. A large group of decoration light string comprising multiple luminaries by using electrical device connect to the control device and its electrical conductor via serial, parallel or serial and parallel circuit loop become little group decoration light string, then using multiple little group decoration light strings to connect and establish the larger group decoration light string, and the function of this control device able to control the light string to bright or dark and flashing randomly or orderly to establish movement trend shape

13. A large group decoration light string as claimed in claim 12, wherein the luminaries being connected with multiple conductors by use the non-electrical connectors twisted with electrical conductor to increase the connecting enhancement.

14. A large group decoration light string as claimed in claim 12, wherein the luminaries being vacuum bulbs, bulbs filling with air and LED to be installed the lamp base and lamp holder.

15. A large group decoration light string as claimed in claim 12, wherein the power connectors are using single or multiple power sockets or tail connectors connected mutually.

16. A large group decoration light string as claimed in claim 12, wherein the luminaries being connected with electrical conductors, non-electrical connectors, fixed device or mutual twisted to establish little group decoration light string.

17. A large group decoration light string as claimed in claim 12, wherein the luminaries connected to the fixed device, supporting frame or film, the lamp holder or electrical conductors establish plane or three dimensional little group decoration light string.

18. A large group decoration light string as claimed in claim 12, wherein the little group decoration light string being connected with electrical conductors, non-electrical connectors or fixed device to establish a large group decoration light string.

19. A large group decoration light string as claimed in claim 12, wherein the little group decoration light string can be separated, over lapping or including one or the other to establish plane or three dimensional large group decoration light string.

20. A large group decoration light string as claimed in claim 12, wherein using the same or different scale of little group decoration light string.

21. A large group decoration light string as claimed in claim 12, wherein using the same or different shape of little group decoration light string.

22. A large group decoration light string as claimed in claim 12, wherein using many little group decoration light strings to adjust their frame space or distance apart from one to the other become changeable shape.

23. A large group decoration light string as claimed in claim 12, wherein use the control device let many little group decoration light strings to adjust their luminaries flashing same time or different time changing brightness or darkness.

24. A large group decoration light string as claimed in claim 12, wherein using the control device to let many little group decoration light strings flashing, starting from the first group decoration light string flashing, then after a certain period of time, the second group decoration light string flashing, and after a certain period of time, the third group decoration light string flashing and so on so for, and all group decoration light strings being died out simultaneously until all the groups of light having done, then repeating the motion thus appearing just like fireworks shape.

25. A large group decoration light string as claimed in claim 12, wherein use the control device to control the luminaries in many little group decoration light strings orderly on or off, adjust the speed so that the motion saving on the temp sense, and It being a straight line from the sense point of view then extent it to round shape or random motional shape.

26. A large group decoration light string as claimed in claim 12, wherein using the control device to control the luminaries in many little group decoration light strings working simultaneous fully or partially, so that the luminaries flashing fully or partially synchronous bright up or dying out.

27. A large group decoration light string as claimed in claim 26, wherein using the control device either manually or automatically to start or weight device, so that the luminaries to be started and operated manually or automatically, and this operation transmitting the data to the signal processor via either IR or RF.
